(19) United States
(12) Patent Application Publication
(10) Pub. No.: US 2024/0391370 A1
(43) Pub. Date: Nov. 28, 2024

(54) VEHICLE SEAT BACKREST

(71) Applicant: FAURECIA Sièges d'Automobile, Nanterre (FR)

(72) Inventors: Didier FOUINAT, Saint Chéron (FR); Didier DURIEZ, Le Plessis-Pâté (FR)

(21) Appl. No.: 18/696,068

(22) PCT Filed: Sep. 26, 2022
(86) PCT No.: PCT/FR2022/051808

§ 371 Date: Mar. 27, 2024

(30) Foreign Application Priority Data
Sep. 30, 2021 (FR) FR2110343

(51) Int. Cl. B60N 2/64; B60N 2/58; B60N 2/68; B60N 2/90

(52) U.S. Cl. CPC B60N 2/64; B60N 2/5883; B60N 2/68; B60N 2/986

(57) ABSTRACT

A backrest of a vehicle seat comprises a backrest frame, a rear padding element attached to the backrest frame, two side cushions, each side cushion comprising a lateral foam block covered with a respective side cover, the side covers and the rear padding element constituting an integral sub-assembly.

### TECHNICAL FIELD

The present description relates to a vehicle seat backrest, in particular a motor vehicle seat backrest. The invention also relates to a vehicle seat comprising such a backrest, a method for mounting a vehicle seat backrest and a vehicle seat comprising such a backrest.

### PRIOR ART

In the automotive field, in particular, it is known to produce a vehicle seat backrest by covering a backrest frame with foam. The assembly is then covered with a cover.

The seat backrest can integrate numerous comfort and/or safety functions. To do this, it is known to attach a support to the frame of the backrest, to mount the different elements necessary for implementing the comfort and/or safety functions on the support or on the frame of the backrest, and then to cover the foam assembly thus obtained forming the padding. A cover then covers the assembly.

Depending on the number and the complexity of the functions to be integrated into the backrest of a seat, the assembly of a backrest can be very different on an assembly line.

Furthermore, the assembly of such a backrest is generally carried out at least in part by one operator, who must therefore be capable of assembling the different variants of the same backrest.

There is therefore a need for a seat backrest that can be assembled substantially identically regardless of the functions that it integrates, with a substantially constant assembly time.

There is also a need for a seat backrest that can easily be produced on an assembly line.

The present description aims to propose a solution for at least some of the aforementioned needs.

### SUMMARY

To this end, a vehicle seat backrest is disclosed comprising a backrest frame, a rear padding element attached to the backrest frame, two side cushions, each side cushion comprising a lateral foam block covered with a respective side cover, the side covers and the rear padding element constituting an integral subassembly.

Thus, the side cushions of such a seat backrest are easily achievable.

According to preferred embodiments, the vehicle seat backrest comprises one or more of the following features, taken alone or in combination:
the rear padding element is a rear panel;
the rear panel is at least partially flexible,
the rear panel is at least partially made of foam, preferably covered with a skin;
the rear panel is obtained by:
   forming an outer layer by applying at least one layer of paint against a first forming surface of a production tool;
   applying a skin, preferably made of water-free synthetic material, in particular of water-free polyurethane, against an inner surface of the outer layer; and by
   applying a foam layer against an inner surface of the skin, the foam layer having a formulation containing water and a foaming catalyst at the time of its application to the skin;
the rear panel comprises an insert overmolded by the foam;
the rear padding element is a web, preferably attached to the backrest frame;
each side cover is sewn to the rear padding element, in particular on the rear panel or the web, if applicable;
each side cover is attached to reliefs for attaching the rear padding element, in particular of the rear panel insert, if applicable;
each side cover is attached to attachment reliefs of the backrest frame;
the rear panel, in particular the insert, if applicable, comprises reliefs for attachment to the backrest frame, in particular elastic interlocking reliefs;
each lateral foam block is held in position around a respective upright of the backrest frame by means of the respective side cover, preferably only by means of the respective side cover;
each lateral foam block is folded in order to at least partially cover three separate faces of the associated upright of the backrest frame, in particular one face of the front-facing upright of the vehicle seat, one face of the upright oriented toward the other upright, and one face of the upright oriented in the direction opposite to the other upright;
the vehicle seat backrest further comprises at least one central padding module, arranged between the two side cushions, the central padding module preferably being adapted to be attached to the backrest frame independently of the side cushions, the central padding module preferably being attached to the backrest frame independently of the side cushions;
the central padding module comprises a separate padding of the side cushions;
the central padding module comprises at least one support, attached to the backrest frame, and a central foam block covering all or part of the support;
at least one side cushion comprises a lateral airbag device, attached to an upright of the backrest frame and at least partially surrounded by the foam block of said side cushion; and
the rear panel comprises a skin, preferably made of synthetic material, in particular of water-free polyurethane, the skin being covered on a first face by at least one layer of paint, the skin being rigidly connected by a second face opposite the first face to a layer of foam, the layer of foam preferably being made from polyurethane containing water.

According to another aspect, also disclosed is a motor vehicle seat comprising a seat bottom with a seat bottom frame and a backrest as described above in all combinations thereof, the backrest frame being attached to the seat bottom frame, preferably so as to be pivotable about a transverse axis.

According to another aspect, also disclosed is a method for manufacturing a backrest for a motor vehicle seat as described above, in all combinations thereof, comprising the steps of:
i) providing a backrest frame;
ii) providing an integral subassembly, consisting of a rear padding element and two side covers of side cushions;
iii) attaching the rear padding element to the backrest frame;
iv) filling each side cover with at least one foam block at least partially surrounding an upright of the backrest frame to form two side cushions, step
iv) being preferably carried out after step iii).

Step ii) may comprise the sub-steps of:
a) providing a rear padding element;
b) providing two side covers,
c) attaching the two side covers to the rear padding element.

Step a) may comprise the sub-steps of:
forming an outer layer by applying at least one layer of paint against a first forming surface of a production tool;
applying a skin, preferably made of water-free synthetic material, in particular of water-free polyurethane, against an inner surface of the outer layer; and
applying a foam layer against an inner surface of the skin, the foam layer having a formulation containing water and a foaming catalyst at the time of its application to the skin.

The skin may be made of substantially non-cellular polyurethane.

The foam layer may be made of a cellular polyurethane foam.

Also disclosed is a method for manufacturing a vehicle seat comprising the following steps:
providing a seat bottom with a seat bottom frame;
assembling a backrest by implementing the method described above in all combinations thereof; and
attaching the backrest to the seat bottom, preferably so that the backrest can pivot about a transverse axis relative to the seat bottom.

### BRIEF DESCRIPTION OF THE DRAWINGS

Other features and advantages will become apparent during the following description of one of its embodiments, given by way of non-limiting example, with reference to the attached drawings. On the drawings:

FIG. 1 schematically shows a side view of a first example of a vehicle seat;

FIG. 2 schematically shows in perspective the backrest of the vehicle seat of FIG. 1;

FIG. 3 schematically shows an exploded view of the vehicle seat backrest of FIG. 2;

FIG. 4 schematically shows in perspective the frame of the vehicle seat backrest of FIG. 2 and FIG. 3;

FIG. 5 schematically shows a perspective view of an example of a sub-assembly of a rear padding element and side airbag side covers that can be implemented in the vehicle seat backrest of FIG. 2 and FIG. 3;

FIG. 6 schematically shows in cross-section the sub-assembly of FIG. 5 mounted on the backrest frame of FIG. 4, the foam blocks of the side cushions being inserted into the side covers;

FIG. 7 schematically shows the sub-assembly of FIG. 5 attached to the backrest frame of FIG. 4;

FIG. 8 schematically shows in cross-section a detail of the sub-assembly of FIG. 5 mounted on the backrest frame of FIG. 4, a foam block of the side cushion shown being inserted into the corresponding side cover, a lateral airbag device being attached to the upright of the frame;

FIG. 9 schematically shows in cross-section a rear panel that can be implemented in the sub-assembly of FIG. 5;

FIG. 10 shows a first step of an example of a method for producing the rear panel of FIG. 9;

FIG. 11 shows a second step of an example of a method for producing the rear panel of FIG. 9;

FIG. 12 shows a third step of an example of a method for producing the rear panel of FIG. 9;

FIG. 13 schematically shows a first step of a method for producing another example of a vehicle seat backrest; and

FIG. 14 schematically shows a second step of the method whose first step is shown in FIG. 13.

### DESCRIPTION OF THE EMBODIMENTS

In the various figures, the same references designate identical or similar elements. For simplicity's sake, only the elements that are useful for understanding the described embodiment are shown in the figures and are described in detail below.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a vehicle seat in its normal position of use.

In particular, the longitudinal direction X is understood to mean the longitudinal direction of the seat. The longitudinal direction of the seat is considered to be the same as the longitudinal direction of the motor vehicle wherein the seat is mounted. This longitudinal direction X corresponds to the normal direction in which the vehicle advances. The longitudinal direction X is horizontal. The transverse direction Y of the seat thus corresponds to the transverse or lateral direction of the motor vehicle. This transverse direction corresponds to a direction perpendicular to the normal direction of travel of the vehicle. The transverse direction Y is horizontal. Finally, the vertical direction Z is a vertical direction of the seat, perpendicular to the longitudinal and transverse directions.

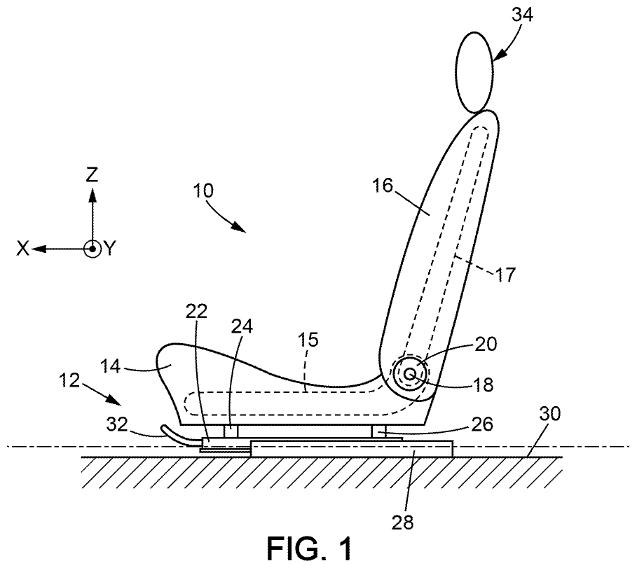

FIG. 1 schematically shows a motor vehicle seat 10 mounted on a slide mechanism 12.

The seat 10 comprises a seat bottom 14, with a seat bottom frame 15, on which a backrest 16, with a backrest frame 17, is mounted. The backrest frame 17 here is pivoting about a transverse axis 18, relative to the seat bottom frame 15. To do this, a hinge mechanism 20 is arranged between the seat bottom frame 15 and the backrest frame 17.

The seat bottom 14 is mounted on movable sections 22, also called slides or male sections, via feet 24, 26. Each movable section 22 is part of a slide 12 and is associated with a fixed section 28. The fixed section 28 is also called “rail” or “female section.” The fixed section 28 is attached to the floor 30 of a motor vehicle.

In this example, the seat 10 comprises a manual control element 32, called a handle, for controlling the sliding of the slides 12. This manual control element 32 makes it possible in particular to lock and unlock stop systems for stopping the sliding of the movable sections 22 relative to the respective fixed sections 28. Once the stop systems have been unlocked, the manual control element 32 can also be used to cause the movable sections 22 to slide relative to their respective fixed sections 28 of the slide 12 in the longitudinal direction X of the slides 12. The fixed 28 and movable 22 sections of the slides 12 are generally metallic.

Alternatively, the displacement of the movable sections 22 relative to the fixed sections 28 is controlled by means of an actuator.

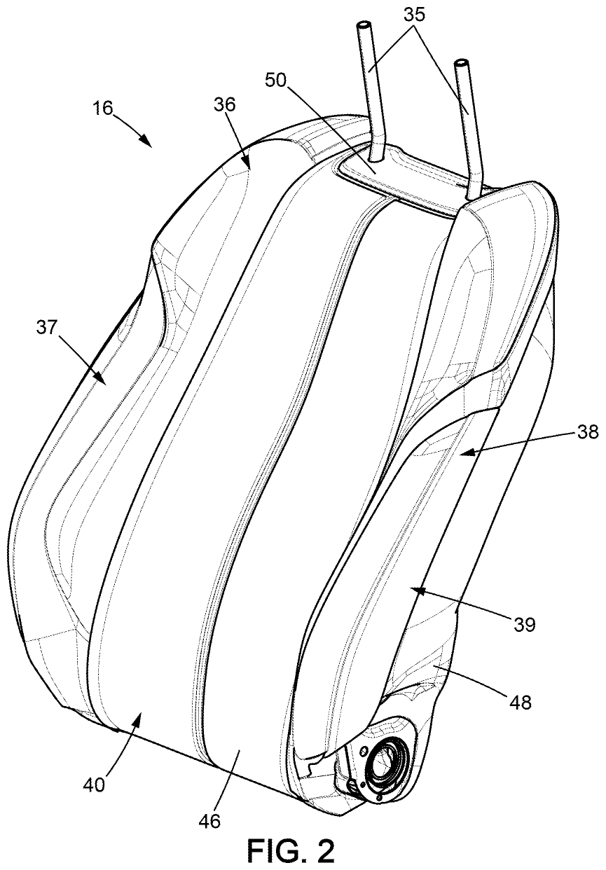

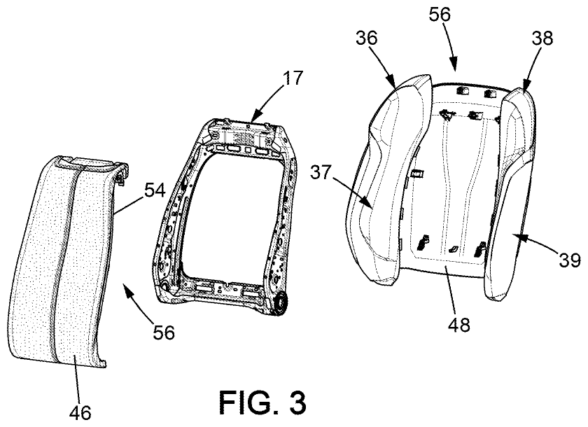

According to the example shown, the seat 10 may also comprise a headrest 34, with a headrest frame 35, partially visible in FIG. 2, in the form of rods 35 attached to the backrest frame 17.

In the following, the backrest 16 of the vehicle seat 10 is described in more detail.

As can be seen in FIG. 2 in particular, the backrest 16 shown essentially comprises a first side cushion 36, a second side cushion 38 and a central padding module 40, such that the first and second side cushions 36, 38 are each arranged on a respective side of the central padding module 40. The central padding module 40 here comprises a foam block 46, the only visible element of the central padding module 40 in FIG. 1. In practice, the foam block 46 can be covered with a cover. The cover of the foam block 46 is preferably independent of the cover 37, 39 of the side cushions 36, 38.

In the example shown, the central padding module 40 forms the support face of the bowl of the backrest 16, that is, the central support part of the seat occupant's back, while the side cushions 36, 38 form the lateral portions protruding relative to the bowl of this same bearing face of the seat occupant's back.

It should be noted here that the central padding module 40 exists prior to its attachment to the backrest frame 17. Thus, the central padding module 40 is not made by overmolding on the backrest frame 17 and/or structural elements that are already rigidly connected to the backrest frame 17. This does not prevent the foam block 46 of the central padding module 40 from being made by overmolding of an optional support of the central padding module 40. However, this overmolding is carried out prior to the attachment of the support in question onto the backrest frame 17.

The backrest 16 further comprises a rear padding element 48, defining the greater part of the rear face of the backrest 16, or even the entirety of the rear face of the backrest 16.

The backrest 16 further comprises, according to the example shown, an upper finishing element 50. The finishing element 50 here surrounds the support rods 35 of the headrest 34.

The central padding module 40 here is attached to the backrest frame 17, independently of the side cushions 36, 38, and vice versa. In other words, the central padding module 40 can be attached to the backrest frame 17 while the side cushions 36, 38 are not attached to the backrest frame 17, and vice versa. Thus, the central padding module 40 is able to be attached to the backrest frame 17 independently of the two side cushions 36, 38. Likewise, the two side cushions 36, 38 are adapted to be attached to the backrest frame 17, independently of the central padding module 40. The central padding module 40 may however be attached to one and/or the other of the side cushions 36, 38. However, preferably, the central padding module 40, on the one hand, and the side cushions 36, 38, on the other hand, are independent in that there is no direct attachment of the central padding module 40 to a side cushion 36, 38 or, vice versa, of a side cushion 36, 38 to the central padding module 40. The foam block 46 of the central padding module 40 may however be tightly mounted between the side cushions 36, 38.

The rear padding element 48 can also be directly attached to the backrest frame 17, preferably independently of the central padding module 40. The rear padding element 48 can be attached to the backrest frame 17 by any suitable means, in particular by screwing or riveting. According to still another example, the rear padding element 48 is elastically snapped onto the backrest frame 17. Advantageously, the rear padding element 48 is adapted to be attached to the front backrest frame 17 or, preferably, after the central padding module 40 is attached. In fact, this can allow access by the rear of the seat 10 to the different elements of the central padding module 40 that must be functionally connected, after the central padding module 40 has been attached to the backrest frame 17, before attaching the rear padding element 48.

For its part, the finishing element 50 is attached, according to the example shown, to the central padding module 40. This finishing element 50 can be attached to the central padding module 40 by any suitable means accessible to a person skilled in the art. In particular, the finishing element 50 can be elastically snapped onto the foam block 46 of the central padding module 40.

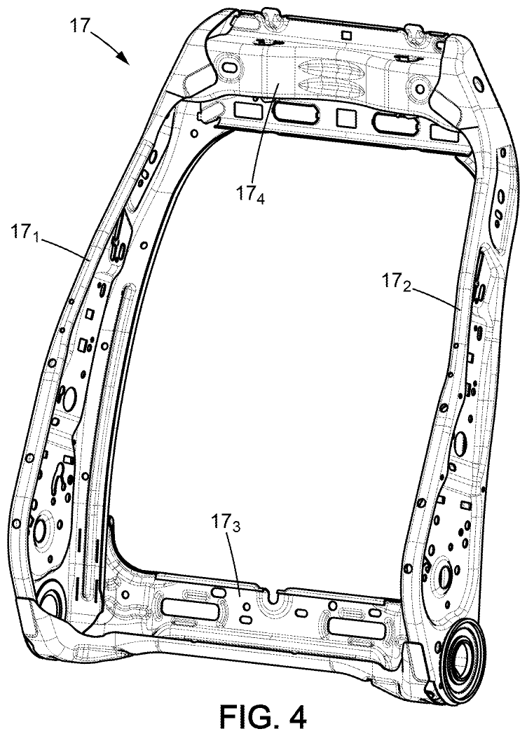

As shown in FIG. 4, the backrest frame 17 essentially comprises a first upright 17₁, a second upright 17₂, a first cross-member 17₃, hereinafter called “lower cross-member 17₃,” and a second cross-member 17₄, hereinafter called “upper cross-member 17₄.” The uprights 17₁, 17₂ and the cross-members 17₃, 17₄ form a backrest frame 17 in the form of a framework. To do this, the uprights 17₁, 17₂ and the cross-members 17₃, 17₄ can be attached together, in particular welded together. Alternatively, the backrest frame 17 is in one piece, the latter for example being molded.

The central padding module 40 is attached to the backrest frame 17.

The central padding module 40 essentially comprises a support 54, for example in the form of a plate. The support 54 is in particular more rigid than the foam block 46 of the central padding module 40. The foam block 46 of the central padding module 40 is attached to the support 54. In particular, the foam block 46 can be overmolded on the support 54. Alternatively, the foam block 46 can be glued or elastically snapped onto the support 54, the foam block 46 preferably having plastic inserts in the latter case, forming elastic interlocking reliefs on the support 54.

The support 54 extends essentially in a longitudinal direction. The longitudinal ends of the support 54 can be curved. Thus, the upper end of the support 54 can rest on the upper cross-member 17₄ of the backrest frame 17. Similarly, the lower end of the support 54 can receive the lower cross-member 17₃ of the backrest frame 17. The upper and lower ends of the support 54 can have means for attachment to the lower 17₃ and upper 17₄ cross-members, respectively, of the backrest frame 17. These means of attachment may in particular comprise:
complementary reliefs, for example for a forced attachment of the central padding module 40 to the backrest frame 17; and/or
corresponding holes for attachment using screws, bolts or rivets, for example; and/or
complementary elastic interlocking reliefs (or clips), for elastic interlocking attachment.

This latter solution appears the most favorable in that it limits the number of parts and manipulations necessary to attach the support 54 to the backrest frame 17.

The support 54 can be equipped with different elements each associated with one or more comfort functions of the occupant of the seat 10, such as a fan for ventilating the occupant of the seat, or inflatable pockets connected to a pump, in order to massage the occupant of the seat. Other comfort functions can be associated with the support 54. In particular, one or more loudspeakers and/or one or more vibrating devices (“exciters”) and/or one or more resistive wires for heating the back of the occupant of the vehicle seat 10 can be attached to the support 54. Preferably, the loudspeaker or loudspeakers and/or the vibrating device(s) and/or the resistive wire(s) are arranged between the support 54 and the foam block 46 of the central padding module 40 or at least partially received in the foam block 46 of the central padding module 40.

Subsequently, the production of the side cushions 36, 38 is described in more detail, from an integral subassembly 56, consisting of the rear padding element 48 and respective side covers 37, 39 of the side cushions 36, 38. More specifically, the side covers 37, 39 of the side cushions 36, 38 are here attached to the rear padding element 48, and in particular are sewn to the rear padding element 48.

Here, the rear padding element 48 comprises a rigid insert 58 on which a foam block 60 is overmolded. The foam block 60 may be more or less flexible. The rear padding element 48 thus takes the form of a rear panel 62. A skin may be provided on the rear face of the foam block 60, intended to be visible to the occupants of the motor vehicle when the rear padding element 48 is attached to the backrest frame 17. In particular, the skin may be present in the bottom of the mold used to overmold the foam block 60 on the insert 58.

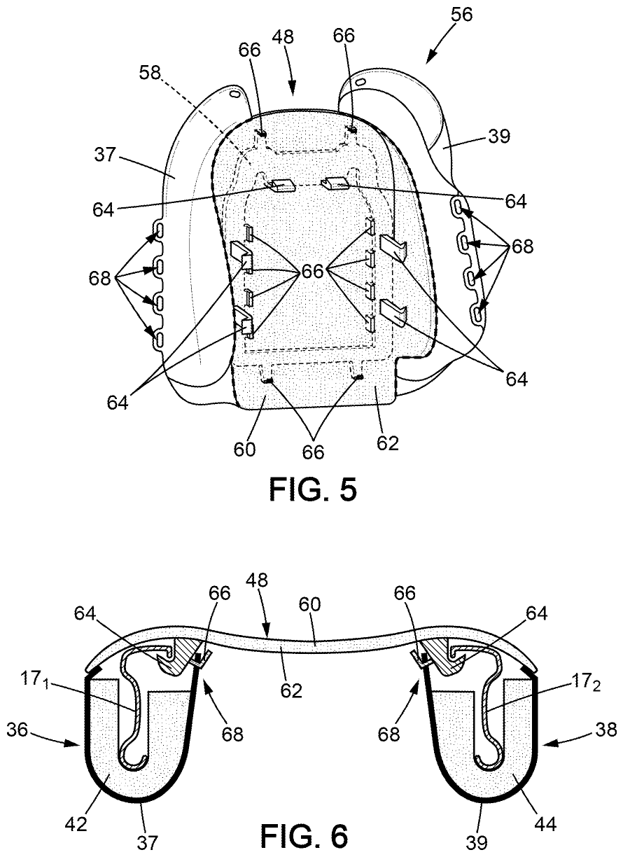

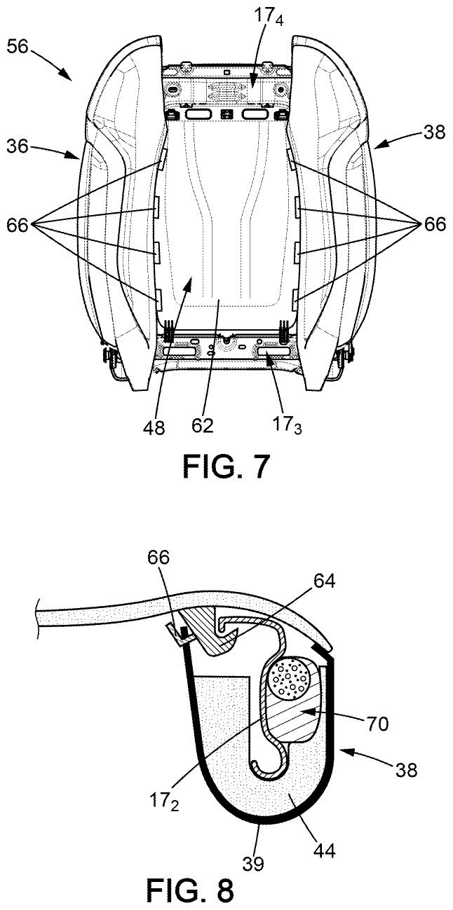

As can be seen in FIG. 5 and FIG. 6, in particular, the insert 58 forms first reliefs 64 for attaching the rear padding element 48 to the backrest frame 17. The insert 58 thus ensures the attachment of the rear padding element 48 to the backrest frame 17. Here, the insert 58 forms first attachment reliefs 64 on each of the uprights 17₁, 17₂ and on each of the cross-members 17₃, 17₄ of the backrest frame 17. Alternatively, however, the rear padding element 48 can be attached only to the uprights 17₁, 17₂ or to the cross-members 17₃, 17₄ of the backrest frame 17. The rear padding element 48 can also be attached to the two uprights 17₁, 17₂ of the back frame 17 and to only one of the two cross-members 17₃, 17₄, in particular, only to the top cross-member 17₄. The first attachment reliefs 64 may in particular be elastic interlocking reliefs.

The insert 58 also forms second reliefs 66 for attaching the side covers 37, 39. The second reliefs 66 here project relative to the rest of the insert 58. The second reliefs 66 make it possible to stretch each side cover 37, 39 around the lateral foam block 42, 44 of the respective cushion 36, 38.

The side covers 37, 39 are here sewn onto the rear padding element 48, more specifically here on the foam block 60 overmolded on the insert 58. The side covers 37, 39 are thus made integral with the rear padding element 48. Other means for attaching the side covers 37, 39 to the rear padding element 48 can be implemented. In particular, the side covers 37, 39 can be bonded to the rear padding element 48.

Each side cover 37, 39 here forms reliefs 68 complementary to the second reliefs 66 of the insert 58. Here, the reliefs 68 of the covers 37, 39, take the form of holes adapted to receive the second reliefs 66 of the insert 58.

Each side cushion 36, 38 further comprises a respective foam block 42, 44. Here, the foam blocks 42, 44 are separate or independent. Advantageously, each foam block 42, 44 is in particular free of any means of attachment to the backrest frame 17, in particular to the respective upright 17₁, 17₂ of the backrest frame, to the associated cover 37, 39 and/or to the rear padding element 48, in particular to the first and second reliefs 64, 66 of the insert 58. The foam blocks 42, 44 are also separate and independent of the foam block 46 of the central padding module 40.

Each foam block 42, 44 is thus preferably held in position only by the side cover 37, 39 and the upright 17₁, 17₂ of the associated back frame 17, the side cover 37, 39 being stretched around the associated foam block 42, 44. In particular, each foam block 42, 44 can be arranged to at least partially cover three faces of the associated upright 17₁, 17₂, in particular the front-oriented faces of the vehicle seat 10, toward the other upright 17₂, 17₁ of the backrest frame 17, and in the opposite direction to the other upright 17₂, 17₁.

As shown in FIG. 8, an airbag device 70 can be attached to one and/or the other of the uprights 17₁, 17₂ and be covered by the associated foam block 42, 44 of the side cushion 36, 38.

The backrest 16 as just described is particularly simple to manufacture.

Thus, a method for manufacturing such a backrest 16 may comprise a first step consisting in providing a backrest frame 17, an integral subassembly 56, consisting of the rear padding element 48 and side covers 37, 39. In this step, the backrest frame 17 may optionally already be attached to the seat frame 15 and/or already have received all or part of the headrest frame 35. In particular, the support rods of the headrest can already be attached to the backrest frame 17.

Secondly, the rear padding element 48 is attached to the backrest frame 17, here by means of the first reliefs 64 for attaching the insert 58 of the rear padding element 48.

Once the rear padding element 48 is attached to the backrest frame 17, each foam block 42, 44 is placed around the respective upright 17₁, 17₂, then the foam block 42, 44 is covered with the associated side cover 37, 39. By attaching the side cover 37, 39 to the rear padding element 48, here by means of the second reliefs 66 of the insert 58, the foam block 42, 44 is held in position in the side cushion 36, 38. Indeed, each side cover 37, 39 is then stretched around the associated foam block 42, 44.

It is then possible to attach the central padding module 40 to the backrest frame 17. Alternatively, the central padding module 40 is attached to the backrest frame 17 before the rear padding element 48. It is also conceivable to attach the rear padding element 48, then the central padding module 40 before attaching the side covers 37, 39 in order to maintain the foam blocks 42, 44 in position.

Finally, according to the example shown, the finishing element 50 is attached.

Thus, the assembly of the seat 10, in particular of the backrest, is very simple to carry out. In addition, it may be identical or substantially identical, regardless of functions integrated into the backrest 16, which are mostly carried by the central padding module 40. The assembly line for such a range of seats is thus simpler and easier to manage.

In the following, variants are described of the rear padding element 48 that can be implemented in the sub-assembly 56 that has just been described, as well as methods for manufacturing such a rear padding element 48.

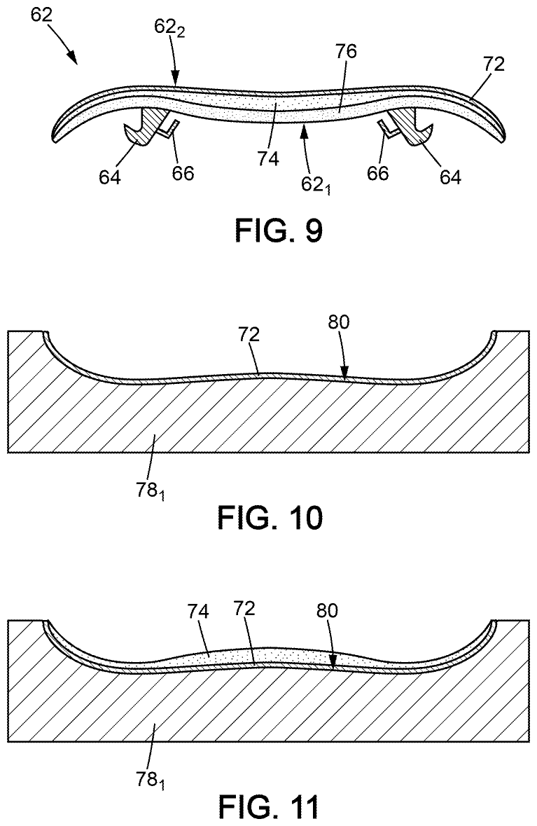

FIG. 9 shows a variant of the panel 62 described above. The panel 62 comprises an inner surface 62₁, intended to be oriented toward the inside of the seat 10, and an outer surface 62₂, opposite the interior surface 62₁ and intended to be oriented toward the outside of the seat 10. Thus, the outer surface 62₂ is at least partially visible from outside the seat 10.

The panel 62 comprises, as shown in FIG. 9, an outer layer 72, a skin 74, and a foam layer 76.

The outer layer 72 forms the outer surface 62₂ of the panel 62, that is, in this case, the back of the backrest 16. The outer layer 72 is for example formed by at least one layer of paint making it possible to impart a particular appearance to the outer surface 62₂ of the panel 62. It is understood that in the present application, “layer of paint” is understood to mean a layer of paint or varnish. In particular, it is possible to choose the color and/or the gloss of the at least one layer of paint to obtain a particular aspect. The paint used is for example a water-based paint or a paint based on another chemical solvent. The outer layer 72 has for example a thickness of between 5 pm and 120 pm, preferably between 10 pm and 80 pm, for example around 25 pm. It is understood that the outer layer 72 may comprise several layers of paint, depending on the appearance and/or other properties desired for the outer layer 72. Thus, the outer layer 72 may in particular have properties that are anti-abrasive, wear-resistant, light-resistant, and resistant to chemicals. The outer layer 72 may also have a pattern, such as graining, a logo or the like, this pattern being able to be formed on the outer layer 72 during the production of the panel 62, as will be described later.

The skin 74 is for example made of synthetic material. The skin 74 extends over the inner surface of the outer layer 72. The skin 74 thus forms a support for the outer layer 72 by adhering thereto. The skin 74 has an outer surface, extending over the inner surface of the outer layer 72, and an inner surface, opposite the outer surface. The skin 74 forms a substantially rigid or semi-rigid shell of the panel 62.

To this end, the skin 74 is here formed of a water-free synthetic material. More particularly, the skin 74 may be a foam layer having few or no cells, or non-cellular foam. In other words, the skin 74 contains few or no air bubbles, which gives it a certain rigidity. In practice, the skin 74 may contain a limited number of air bubbles, referred to as residual bubbles, the presence of which is due to the method for applying the skin 74, which will be described later.

The skin 74 is for example made of an elastomeric material, for example a material resulting from a polyol-isocyanate reaction. According to one embodiment, the skin 74 is made of substantially non-cellular, water-free polyurethane. Thus, the skin 74 has a similar behavior to a plastic coated textile (PET) or a leather textile.

The skin 74 has for example a thickness of between 0.1 mm and 3 mm, preferably between 0.5 mm and 2 mm. The skin 74 may have a variable thickness depending on the characteristics desired for the rear panel 62, in particular in terms of rigidity. The skin 74 has for example a density of between 400 kg·m⁻³ and 1500 kg·m⁻³, preferably between 800 kg·m⁻³. and 1200 kg·m⁻³. The skin 74 may have a tensile strength of between 1 Mpa and 50 Mpa, preferably between 3 Mpa and 15 Mpa, measured according to the method DIN EN ISO 527-3/2/100. The skin 74 for example has a tear strength of between 0.5 N·mm⁻¹ and 30 N·mm⁻¹, preferably greater than 4 N·mm⁻¹, preferably greater than 6 N·mm¹, measured according to the DIN EN ISO 13937-2 method.

The foam layer 76 extends over the inner surface of the skin 74 and adheres thereto. The foam layer 76 has an outer surface, extending over the inner surface of the skin 74, and an inner surface, opposite the outer surface. The foam layer 76 forms a padding of the rear panel 62. The foam layer 76 thus has a certain flexibility. In particular, the foam layer 76 is more flexible than the skin 74.

The foam layer 76 is for example made of a synthetic material having a formulation containing water. More particularly, the foam layer 76 is a layer of cellular foam, that is, a layer of foam containing air bubbles, in particular a large number of air bubbles. The cells of the foam layer 76 are obtained during the chemical reaction making it possible to obtain the foam layer 76 as will be described later.

The foam layer 76 is for example made of an elastomeric material, for example a material resulting from a polyol-isocyanate reaction using a foaming catalyst. The foam layer 76 is thus for example made of a polyurethane foam containing water.

The foam layer 76 may have a thickness of between 1 mm and 15 mm, preferably between 4 mm and 9 mm. It should be noted that the foam layer 76 may have a variable thickness depending on the desired characteristics of the rear panel 62, in particular in terms of flexibility. The foam layer 76 has for example a rigidity of between 3 N/30 mm and 45 N/30 mm, preferably between 3 N/30 mm and 25 N/30 mm.

As can be seen in FIG. 9, the foam layer 76 can be integral with the first and second attachment reliefs 64, 66 described above. In particular, each first or second attachment relief 64, 66 can be formed from a separate insert, attached to the foam layer 76. Each insert can be attached to the foam layer 76 by overmolding the foam layer 76 on the insert under consideration. Alternatively, the first and second attachment reliefs 64, 66, or at least a portion thereof, can be integral with one another, in particular by being formed by a single insert.

A rear panel 62 as described above has a satisfactory appearance on its outer surface. Such a rear panel 62 can also be sufficiently flexible to allow the attachment of the covers 37, 39 of the cushions 36, 38, on the rear panel 62, in particular by sewing.

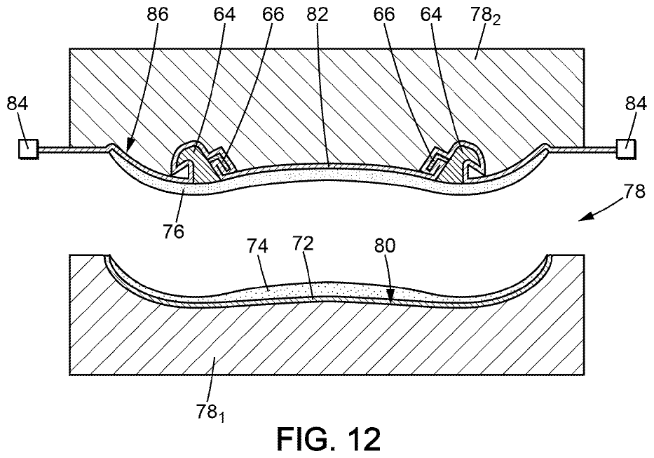

An example of a method for producing such a rear panel 62 is described herebelow, with reference to FIG. 10, FIG. 11 and FIG. 12.

The rear panel 62 is produced in a production tool 78 shown in FIG. 10, FIG. 11 and FIG. 12. The production tool 78 is for example a mold, having two complementary parts 78₁, 78₂.

The various steps of the method described below can be carried out while the production tool 78 is heated, in particular the first part 78₁, for example to a temperature close to 70° C.

The outer layer 72 is made by applying at least one layer of paint to a first forming surface 80 so that the outer layer 72 adopts the shape of the first forming surface 80, as shown in FIG. 10. The layer of paint is applied for example by spraying. When the outer layer 72 comprises several layers of paint, these layers are applied successively on the first forming surface 80 from the outside to the inside. In other words, the layer forming the outer surface, for example a first layer of paint, is applied first to the first forming surface 80 then the layer extending immediately against this first layer, for example a layer of paint defining the color of the outer surface, is applied against the first layer lining the first forming surface 80. Heating the first forming surface 80 makes it possible to obtain rapid drying of the outer layer 72.

A demolding agent may first be applied to the first forming surface 80, before the production of the outer layer 72. In this case, the layer(s) of paint are applied to the demolding agent lining the first forming surface 80.

The skin 74 is then applied against the inner surface of the outer layer 72, as shown in FIG. 11. The skin 74 is applied, for example, by spraying the material forming the skin 74 against the inner surface of the outer layer 72. The skin 74 is for example applied to the outer layer 72 while the outer layer 72 is not yet dry, in order to ensure the adhesion between the skin 74 and the outer layer 72. The material of the skin 74 is kept in the viscous state after its application and before the application of the foam layer 76, for example due to the heating of the first part 78₁ of the production tool 78.

The foam layer 76 is then applied to the inner surface of the skin 74.

According to the example shown in FIG. 12, the foam layer 76 is previously formed on a functional film 82 before being applied with the functional film 82 on the inner surface of the skin 74. The functional film 82 is for example a transfer film. The application of the foam layer 76 to the functional film 82 is for example carried out while the functional film 82 is stretched in a frame 84 by applying a foam precursor material to one of the faces of the functional film 82. The foam precursor material makes it possible to form the foam layer 76 by chemical reaction, in particular by means of a foaming catalyst, as described above. The chemical reaction creates a cellular foam on the face of the functional film 82. The assembly formed by the foam layer 76 and by the functional film 82 is then applied to the inner surface of the skin 74, preferably while the foam layer 76 is in the viscous state. The foam precursor material is for example applied by spraying onto the functional film 82. When the functional film 82 is a transfer film, intended to be removed after the foam layer 76 is adhered to the skin 74, the inner surface of the foam layer 76 is applied to the functional film 82, as shown in FIG. 12, and the outer surface of the foam layer 76 is applied to the inner surface of the skin 74. Alternatively, for a functional film 82 other than a transfer film, the functional film 82 may extend over the outer surface of the foam layer 76 and be applied to the inner surface of the skin 74 so as to be permanently attached in the rear panel 62. In every case, when the application is done while the skin 74 is in the viscous state, the adhesion between the foam layer 76, also in the viscous state, or with the functional film 82, is ensured.

As shown in FIG. 12, the foam layer 76 can be overmolded on the first and/or second attachment reliefs 64, 66. If applicable, the functional transfer film 82 may extend around the first and/or second attachment reliefs 64, 66.

According to the embodiment shown in FIG. 12, the assembly formed by the foam layer 76, first and/or second attachment reliefs 64, 66 and the functional film 82, if applicable, is preformed before application to the inner surface of the skin 74 in order to acquire the shape of the inner surface of the rear panel 62. In this case, this assembly is placed against a second forming surface 86 of the second part 78₂ of the production tool 78. The second forming surface 86 here has the shape of the inner surface of the rear panel 62. The second part 78₂ of the production tool 78, in particular the second forming surface 86, can be heated.

The rear panel 62 is then made by approaching the second part 78₂ of the tool 78 for producing the first part 78₁ so as to cause the foam layer 76 to adhere to the inner surface of the skin 74. After cooling and hardening of the skin 74 and the foam layer 76, the rear panel 62 forms a coherent assembly.

The first and second portions 78₁, 78₂ of the production tool 78 can then be separated and the rear panel 62 may be removed from the production tool 78. This operation is facilitated when a demolding agent has been applied to the first forming surface 80. When the functional film 82 is a transfer film, it is removed from the inner surface of the foam layer 76 after application of the outer surface of the foam layer 76 to the inner surface of the skin 74.

It is then possible to attach, in particular by sewing, the covers 37, 39 to the rear panel 62.

As a variant to the example shown in FIG. 12, the foam layer 76 may first be applied to the inner surface of the skin 74 and then the second part 78₂ of the production tool 78 is moved toward the first part 78₁ so as to apply the second forming surface 86 to the inner surface of the foam layer 76 or of the functional film 82, as applicable, in order to impart its shape to the foam layer 76 to secure this foam layer 76 to the skin 74.

The embodiment described above thus makes it possible to obtain a finished rear panel 62 in one operating cycle of the production tool 78. However, the production method is capable of numerous variants accessible to a person skilled in the art.

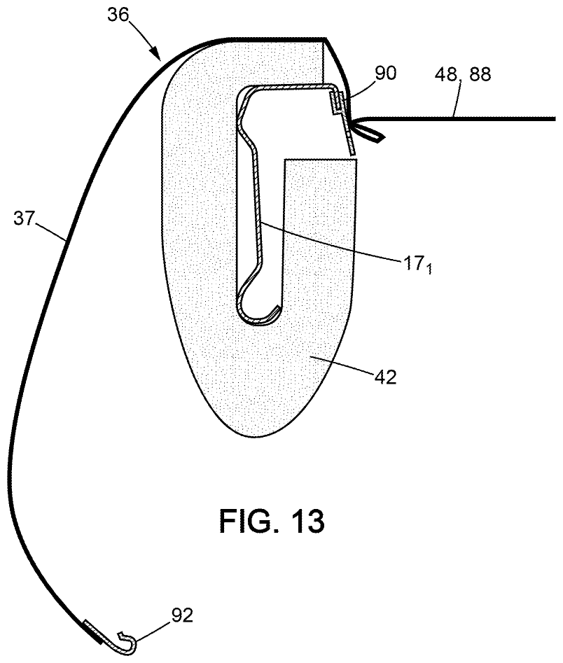

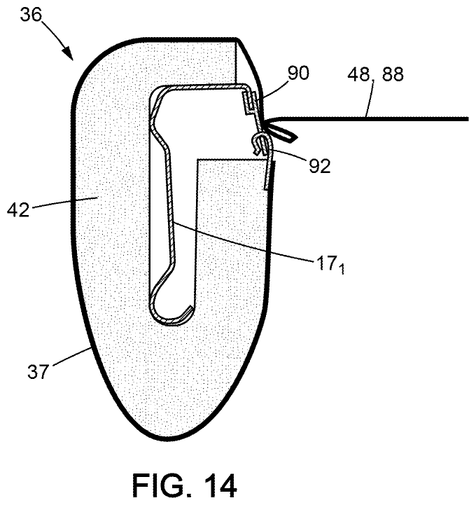

FIG. 13 and FIG. 14 illustrate a variant, wherein the rear padding element 48 consists of a web 88, in particular a textile web (or curtain), and attachment supports 90 of the web 88. The web 88 is attached to the backrest frame 17, in particular to the uprights 17₁, 17₂, by means of the attachment supports 90 which are attached to the web 88. For example, the web 88 is sewn or glued onto the attachment supports 90. Alternatively, the web 88 defines recesses for receiving the attachment supports 90. Each attachment support 90 for example forms an attachment relief, for example an elastic interlocking relief, to the backrest frame 17, and in particular to an upright 17₁, 17₂ of the backrest frame 17.

Here, the side covers 37, 39 are also attached to the attachment supports 90. Alternatively, the side covers 37, 39 are attached to the web 88, in particular are sewn or bonded to the web 88.

In order to maintain each foam block 42, 44 in position, the associated side cover 37, 39 here comprises hooks 92 received in holes of the attachment supports 90. Each side cover 37, 39 is thus stretched around the associated foam block 42, 44.

The present invention is not limited to the examples described above. On the contrary, the invention is capable of numerous variants accessible to a person skilled in the art.

Thus, in the example shown, the central padding module 40 comprises a support and a foam block attached to the support. Alternatively, the central padding module may have no support, or even comprise only one foam block. When the central padding module has no support as described above, it may comprise rigid inserts, incorporated into the foam block, to facilitate the attachment thereof to the backrest frame. Such inserts can be incorporated by overmolding the corresponding foam block on these inserts. “Rigid” is understood here to mean that the inserts are in particular more rigid than the foam.

The support 54 of the central padding module 40 can also take forms other than what is described above. In particular, the support 54 may be a frame comprising two cross-members, preferably rigid, and two uprights, rigid or flexible, spring elements, in particular elastic wires extending between the cross-members and/or between the uprights.

The order of attachment of the central padding module 40 and the subassembly formed by the rear padding element 48 and the side covers 37, 39 may depend on the geometry of the backrest frame 17, the support 54 of the central padding module 40 and their attachments on the backrest frame 17, in particular.

The rear padding element 48 may take shapes other than those indicated above. In particular, the rear padding element 48 may take the shape of a shell.

The side covers 37, 39 can be attached to the rear padding element by any means accessible to a person skilled in the art, other than the gluing or the seam already mentioned above.

1-23. (canceled)

24. A backrest for a vehicle seat comprising
a backrest frame,
a rear padding element attached to the backrest frame,
two side cushions, each side cushion comprising a lateral foam block covered with a respective side cover, the side covers and the rear padding element constituting an integral subassembly.

25. The vehicle seat backrest according to claim 24, wherein the rear padding element is a rear panel.

26. The vehicle seat backrest according to claim 25, wherein the rear panel (62) is at least partially flexible.

27. The vehicle seat backrest according to claim 26, wherein the rear panel is at least partially foam.

28. The vehicle seat backrest according to claim 27, wherein the rear panel is obtained by:
forming an outer layer by applying at least one layer of paint against a first forming surface of a production tool;
applying a skin against an inner surface of the outer layer; and by
applying a foam layer against an inner surface of the skin, the foam layer having a formulation containing water and a foaming catalyst at the time of its application to the skin.

29. The vehicle seat backrest according to claim 25, wherein the rear panel comprises an insert overmolded by the foam.

30. The vehicle seat backrest according to claim 24, wherein the rear padding element is a web.

31. The vehicle seat backrest according to claim 24, wherein each side cover is sewn to the rear padding element.

32. The vehicle seat backrest according to claim 24, wherein each side cover is attached to attachment reliefs of the rear padding element.

33. The vehicle seat backrest according to claim 24, wherein each side cover is attached to attachment reliefs of the backrest frame.

34. The vehicle seat backrest according to claim 25, wherein the rear panel comprises reliefs for attachment to the backrest frame.

35. The vehicle seat backrest according to claim 24, wherein each lateral foam block is held in position around a respective upright of the backrest frame by means of the respective side cover.

36. The vehicle seat backrest according to claim 24, wherein each lateral foam block is bent to at least partially cover three separate faces of the associated upright of the backrest frame.

37. A vehicle seat backrest according to claim 24, further comprising at least one central padding module, arranged between the two side cushions.

38. A vehicle seat backrest according to claim 37, wherein the central padding module comprises a separate padding of the side cushions.

39. A vehicle seat backrest according to claim 37, wherein the central padding module comprises at least one support, attached to the backrest frame, and a central foam block covering all or part of the support.

40. A vehicle seat backrest according to claim 24, wherein at least one side cushion comprises a lateral airbag device, attached to an upright of the backrest frame and at least partially surrounded by the foam block of said side cushion.

41. A motor vehicle seat comprising a seat bottom with a seat frame and the backrest according to claim 24, the backrest frame being attached to the seat frame.

42. A method for manufacturing the backrest of a motor vehicle seat according claim 24, comprising the following steps:
i) providing a backrest frame;
ii) providing an integral subassembly consisting of a rear padding element and two side covers for side cushions;
iii) attaching the rear padding element to the backrest frame;
iv) filling each side cover with at least one foam block at least partially surrounding an upright of the backrest frame in order to form two side cushions.

43. The method according to claim 42, wherein step ii) comprises the sub-steps of:
a) producing a rear padding element;
b) providing two side covers;
c) attaching the two side covers to the rear padding element.

44. The method according to claim 43, wherein step a) comprises the sub-steps of:
forming an outer layer by applying at least one layer of paint against a first forming surface of a production tool;
applying a skin against an inner surface of the outer layer; and
applying a foam layer against an inner surface of the skin, the foam layer having a formulation containing water and a foaming catalyst at the time of its application to the skin.

45. The method according to claim 44, wherein the skin is made of substantially non-cellular polyurethane.

46. The method according to claim 44, wherein the foam layer is made of a cellular polyurethane foam.
